(19) United States
(12) Patent Application Publication
(10) Pub. No.: US 2016/0304064 A1
(43) Pub. Date: Oct. 20, 2016

(54) WINDSHIELD WIPER ASSEMBLY

(71) Applicant: Philip Gordon McDonell, Calgary (CA)

(72) Inventor: Philip Gordon McDonell, Calgary (CA)

(21) Appl. No.: 14/686,851

(22) Filed: Apr. 15, 2015

(51) Int. Cl. B60S 1/48

(52) U.S. Cl. CPC B60S 1/48; B60S 1/487

(57) ABSTRACT

A windshield wiper assembly includes a washer fluid distribution assembly configured to securely connect to a windshield arm interface. A first squeegee holder is configured to securely receive a first squeegee. A second squeegee holder is configured to securely receive a second squeegee. This is done in such a way that the second squeegee, in use, contacts the windshield once the washer fluid distribution assembly is positioned just so, and the second squeegee holder is spaced apart from the first squeegee holder.

### TECHNICAL FIELD

This document relates to the technical field of (and is not limited to) a windshield wiper assembly or a vehicle having a windshield wiper assembly.

### BACKGROUND

A windscreen wiper or windshield wiper is a device used to remove rain and debris from a windscreen or windshield of a vehicle.

### SUMMARY

It will be appreciated that there exists a need to mitigate (at least in part) at least one problem associated with existing windshield wiper assemblies. After much study of the known systems and methods with experimentation, an understanding of the problem and its solution has been identified and is articulated as follows:

A washer control system within a vehicle is operated to spray a washer fluid onto the windshield by using an electrical pump via washer jets mounted beneath the windshield of a vehicle. The existing washing jet (configured to eject the washer fluid to the windshield) sometimes provides ineffective washer-fluid coverage across the windshield, and leaves dry areas on the windshield of the vehicle. This arrangement becomes worse when the windscreen wipers operate to further thinly spread out the washer fluid across the windshield, thereby creating smudged areas on the windshield. Most drivers cannot safely see through these smudged areas in order to drive their vehicles in a safe manner.

To mitigate, at least in part, at least one problem associated with the existing technology, there is provided (in accordance with a major aspect) a windshield wiper assembly. The windshield wiper assembly is for a first squeegee, a second squeegee and a windshield arm of a vehicle having a windshield and a windshield fluid reservoir configured to contain a washer fluid. The windshield wiper assembly includes (and is not limited to) a washer fluid distribution assembly configured to be mounted to the windshield arm. The washer fluid distribution assembly includes spaced apart squeegee holders configured to securely receive the first squeegee and the second squeegee. The washer fluid distribution assembly provides a washer fluid distribution channel configured to convey, in use, the washer fluid from the windshield fluid reservoir of the vehicle to between the first squeegee and the second squeegee.

To mitigate, at least in part, at least one problem associated with the existing technology, there is provided (in accordance with a major aspect) a windshield wiper assembly. The windshield wiper assembly is for a first squeegee, a second squeegee and a windshield arm of a vehicle having a windshield and a windshield fluid reservoir configured to contain a washer fluid. The windshield wiper assembly includes a washer fluid distribution assembly configured to be mounted (directly or indirectly) to the windshield arm. The washer fluid distribution assembly includes spaced apart squeegee holders configured to securely receive (directly or indirectly) the first squeegee and the second squeegee in such a way that the first squeegee and the second squeegee are spaced apart from each other once securely received by the spaced apart squeegee holders. The washer fluid distribution assembly provides a washer fluid distribution channel configured to convey, in use, the washer fluid from the windshield fluid reservoir of the vehicle to between the first squeegee and the second squeegee held by the spaced apart squeegee holders.

To mitigate, at least in part, at least one problem associated with the existing technology, there is provided (in accordance with a major aspect) a windshield wiper assembly. The windshield wiper assembly is for a first squeegee, a second squeegee and a windshield arm of a vehicle having a windshield and a windshield fluid reservoir configured to contain a washer fluid. The windshield wiper assembly includes (and is not limited to) a windshield arm interface configured to securely connect to the windshield arm of the vehicle in such a way that the windshield arm interface is positioned proximate to the windshield of the vehicle. A washer fluid distribution assembly is configured to securely connect to the windshield arm interface in such a way that the washer fluid distribution assembly is positioned proximate to the windshield of the vehicle once the washer fluid distribution assembly is securely connected to the windshield arm interface. The washer fluid distribution assembly is also configured to provide a first squeegee holder configured to securely receive the first squeegee in such a way that the first squeegee (in use) contacts the windshield once the washer fluid distribution assembly is positioned just so. The washer fluid distribution assembly is also configured to provide a second squeegee holder configured to securely receive the second squeegee in such a way that the second squeegee (in use) contacts the windshield once the washer fluid distribution assembly is positioned just so, and the second squeegee holder is spaced apart from the first squeegee holder.

To mitigate, at least in part, at least one problem associated with the existing technology, there is provided (in accordance with a major aspect) a windshield wiper assembly. The windshield wiper assembly is for a first squeegee, a second squeegee and a windshield arm of a vehicle having a windshield and a windshield fluid reservoir configured to contain a washer fluid. The windshield wiper assembly includes (and is not limited to) a windshield arm interface configured to securely connect to the windshield arm of the vehicle in such a way that the windshield arm interface is positioned proximate to the windshield of the vehicle. A washer fluid distribution assembly securely connects with the windshield arm interface in such a way that the washer fluid distribution assembly is positioned proximate to the windshield of the vehicle once the washer fluid distribution assembly is securely connected to the windshield arm interface. The washer fluid distribution assembly provides a first squeegee holder configured to securely receive the first squeegee in such a way that the first squeegee (in use) contacts the windshield once the washer fluid distribution assembly is positioned just so. The washer fluid distribution assembly provides a second squeegee holder configured to securely receive the second squeegee in such a way that the second squeegee (in use) contacts the windshield once the washer fluid distribution assembly is positioned just so, and the second squeegee holder is spaced apart from the first squeegee holder. The washer fluid distribution assembly provides a washer fluid distribution channel configured to fluidly connect to the windshield fluid reservoir of the vehicle in such a way that the washer fluid distribution channel conveys the washer fluid from the windshield fluid reservoir to the windshield of the vehicle, and the washer fluid distribution channel is positioned between the second squeegee holder and the first squeegee holder. The washer fluid distribution assembly receives a heater assembly configured to convey heat, in use, to the washer fluid distribution assembly. The washer fluid distribution assembly receives a spring assembly configured to impart a biasing force to the first squeegee holder and to the second squeegee holder in such a way that a biasing force urges the first squeegee that is securely received by the first squeegee holder toward the windshield and also urges the second squeegee that is securely received by the second squeegee holder toward the windshield.

To mitigate, at least in part, at least one problem associated with the existing technology, there is provided (in accordance with a major aspect) a windshield wiper assembly. The apparatus includes (and is not limited to) a first squeegee, a second squeegee, a vehicle having a windshield arm, a windshield and a windshield fluid reservoir configured to contain a washer fluid, and a windshield wiper assembly including a windshield arm interface configured to securely connect to the windshield arm of the vehicle in such a way that the windshield arm interface is positioned proximate to the windshield of the vehicle. The washer fluid distribution assembly is configured to securely connect to the windshield arm interface in such a way that the washer fluid distribution assembly is positioned proximate to the windshield of the vehicle once the washer fluid distribution assembly is securely connected to the windshield arm interface. The washer fluid distribution assembly is also configured to provide a first squeegee holder configured to securely receive the first squeegee in such a way that the first squeegee (in use) contacts the windshield once the washer fluid distribution assembly is positioned just so. The washer fluid distribution assembly is also configured to provide a second squeegee holder configured to securely receive the second squeegee in such a way that the second squeegee (in use) contacts the windshield once the washer fluid distribution assembly is positioned just so, and the second squeegee holder is spaced apart from the first squeegee holder.

Other aspects are identified in the claims.

Other aspects and features of the non-limiting embodiments may now become apparent to those skilled in the art upon review of the following detailed description of the non-limiting embodiments with the accompanying drawings.

### BRIEF DESCRIPTION OF THE DRAWINGS

The non-limiting embodiments may be more fully appreciated by reference to the following detailed description of the non-limiting embodiments when taken in conjunction with the accompanying drawings, in which:

FIG. 1A (SHEET 1 of 10 SHEETS) depicts a top view of an embodiment of a windshield wiper assembly for a first squeegee, a second squeegee and a windshield arm of a vehicle having a windshield and a windshield fluid reservoir configured to contain a washer fluid;

FIG. 1B (SHEET 1 of 10 SHEETS) depicts a perspective view of an embodiment of the windshield wiper assembly of FIG. 1A;

FIG. 2 (SHEET 2 of 10 SHEETS) depicts an exploded view of an embodiment of the windshield wiper assembly of FIG. 1A;

FIGS. 3A, 3B, 3C and 3D (SHEETS 3 and 4 of 10 SHEETS) depict views of embodiments of a washer fluid distribution assembly of the windshield wiper assembly of FIG. 1A;

FIGS. 4A and 4B (SHEET 5 of 10 SHEETS) depict views of embodiments of a heater assembly of the windshield wiper assembly of FIG. 1A;

FIG. 5 (SHEET 6 of 10 SHEETS) depicts a central perspective view of a central section of the windshield wiper assembly of FIG. 4A;

FIG. 6 (SHEET 7 of 10 SHEETS) depicts a partially exploded view of a central section of an embodiment of the heater assembly of the windshield wiper assembly of FIG. 4A;

FIG. 7 (SHEET 8 of 10 SHEETS) depicts a perspective view of an embodiment of a check valve assembly of the windshield wiper assembly of FIG. 1A;

FIG. 8 (SHEET 9 of 10 SHEETS) depicts a cross-sectional side view of an embodiment of the check valve assembly of the windshield wiper assembly of FIG. 7; and

FIG. 9 (SHEET 10 of 10 SHEETS) depicts a perspective view of an embodiment of a support bracket of the windshield wiper assembly of FIG. 1A.

The drawings are not necessarily to scale and may be illustrated by phantom lines, diagrammatic representations and fragmentary views. In certain instances, details unnecessary for an understanding of the embodiments (and/or details that render other details difficult to perceive) may have been omitted.

Corresponding reference characters indicate corresponding components throughout the several figures of the drawings. Elements in the several figures are illustrated for simplicity and clarity and have not been drawn to scale. The dimensions of some of the elements in the figures may be emphasized relative to other elements for facilitating an understanding of the various disclosed embodiments. In addition, common, but well-understood, elements that are useful or necessary in commercially feasible embodiments are often not depicted to provide a less obstructed view of the embodiments of the present disclosure.

### LISTING OF REFERENCE NUMERALS USED IN THE DRAWINGS

100 windshield wiper assembly
102 wiper mount housing
104 washer fluid distribution assembly
105 washer fluid hose
106 washer fluid distribution channel
108 heater assembly
109 electrical connector
110 first squeegee holder
111 second squeegee holder
112 spring assembly
113 electrical wire
114A first deflection cover section
1148 second deflection cover section
114 wind deflection cover
116 end caps
118 wiper mounting bracket
120 first squeegee gap
121 second squeegee gap
122 first groove
123 second groove
124 set of washer fluid outlets
126 t-shaped centrally positioned post
127 lamp
128 central portion
129 heater forks
130 heater channel
132 check valve assembly
133 slide direction
134 support bracket
135 fluid flow direction
136 cover channels
138 check valve
140 valve spring
142 inlet
144 outlet
146 first hose connection
148 second hose connection
150 arm receiver
152 electrical receiver
900 first squeegee
901 second squeegee
902 windshield arm
904 vehicle
906 windshield
908 windshield fluid reservoir
910 washer fluid

### DETAILED DESCRIPTION OF THE NON-LIMITING EMBODIMENT(S)

The following detailed description is merely exemplary and is not intended to limit the described embodiments or the application and uses of the described embodiments. As used, the word “exemplary” or “illustrative” means “serving as an example, instance, or illustration.” Any implementation described as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure. The scope of the invention is defined by the claims. For the description, the terms “upper,” “lower,” “left,” “rear,” “right,” “front,” “vertical,” “horizontal,” and derivatives thereof shall relate to the examples as oriented in the drawings. There is no intention to be bound by any expressed or implied theory in the preceding Technical Field, Background, Summary or the following detailed description. It is also to be understood that the devices and processes illustrated in the attached drawings, and described in the following specification, are exemplary embodiments (examples), aspects and/or concepts defined in the appended claims. Hence, dimensions and other physical characteristics relating to the embodiments disclosed are not to be considered as limiting, unless the claims expressly state otherwise. It is understood that the phrase “at least one” is equivalent to “a”. The aspects (examples, alterations, modifications, options, variations, embodiments and any equivalent thereof) are described regarding the drawings. It should be understood that the invention is limited to the subject matter provided by the claims, and that the invention is not limited to the particular aspects depicted and described.

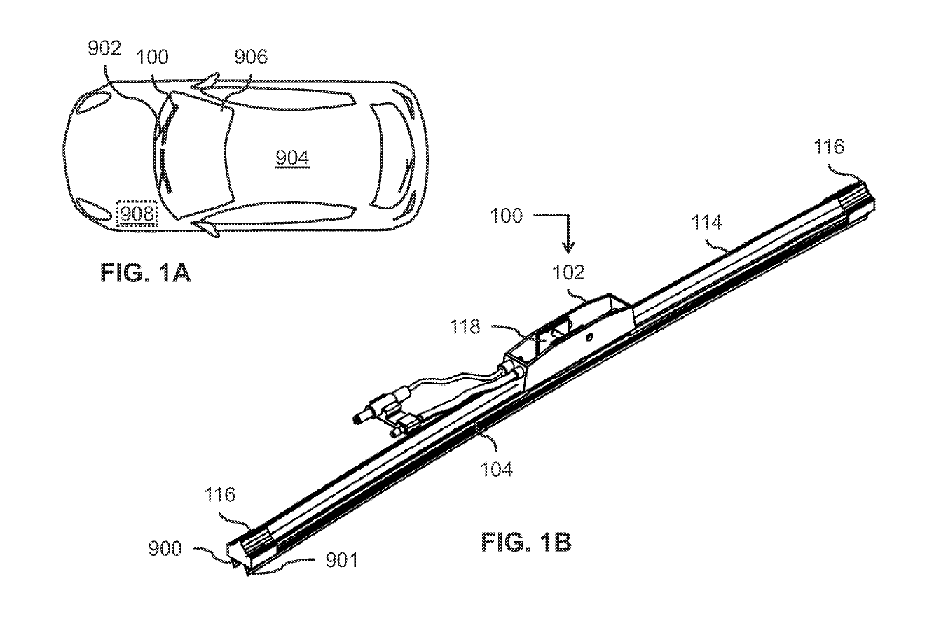

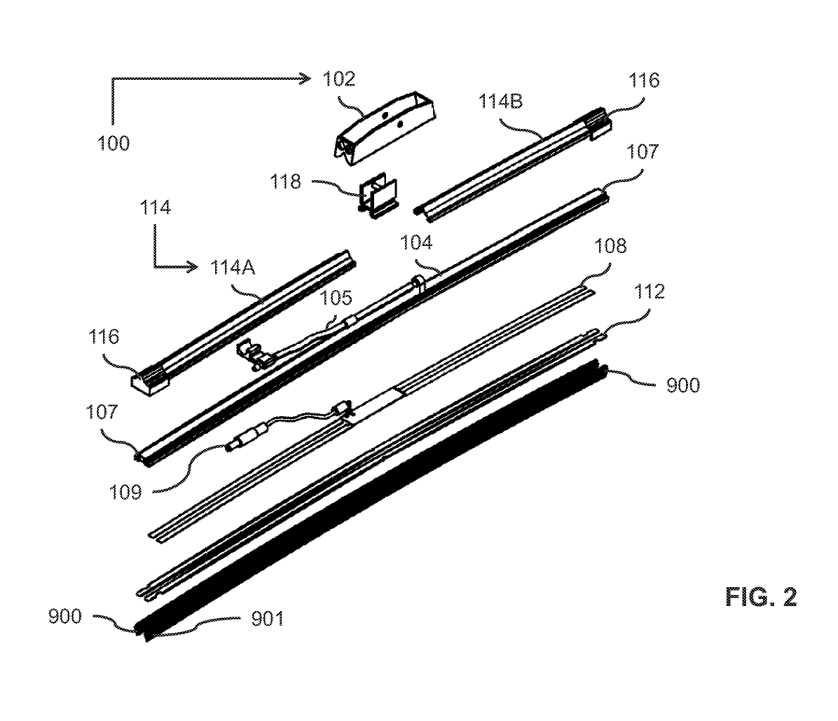

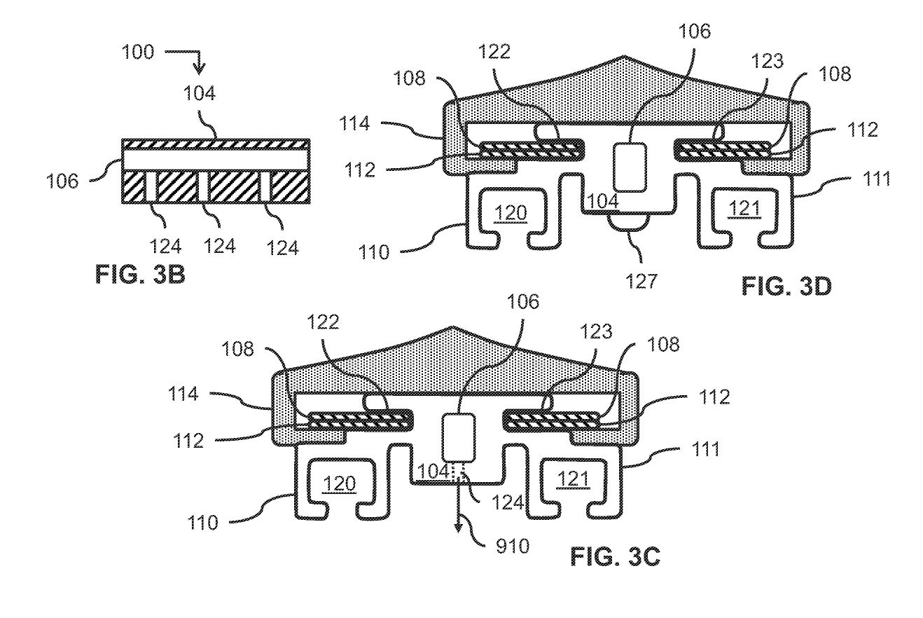

FIG. 1A depicts a top view of an embodiment of a windshield wiper assembly 100 for a first squeegee 900, a second squeegee 901 and a windshield arm 902 of a vehicle 904 having a windshield 906 and a windshield fluid reservoir 908 configured to contain a washer fluid 910. It will be appreciated that the washer fluid 910 is not depicted in FIGS. 1A and 1s depicted in FIG. 3C in which the washer fluid 910 is ejected from the windshield wiper assembly 100. FIG. 1B depicts a perspective view of an embodiment of the windshield wiper assembly 100 of FIG. 1A.

The windshield wiper assembly 100 (in accordance with the embodiments depicted in FIGS. 1A and 1B) is configured to remove (in use) rain and/or debris from the windshield 906 of the vehicle 904 (once installed and operated accordingly). The windshield wiper assembly 100 is also called a windscreen wiper assembly. In use, the windshield wiper assembly 100 is swung back and forth (by a wiper-moving mechanism) over the windshield 906 to push (wipe) water and/or debris from the outer surface of the windshield 906. A technical effect of the windshield wiper assembly 100 is that, once operated, the driver of the vehicle 904 may operate the vehicle 904 in a safe manner because the windshield wiper assembly 100 cleans the windshield 906.

The first squeegee 900 and the second squeegee 901 (depicted in FIG. 1B) are each configured to be securely connected to the windshield wiper assembly 100. Each of the first squeegee 900 and the second squeegee 901 extend downwardly (depend) from the windshield wiper assembly 100, and are each configured to make contact with the windshield 906 (depicted in FIG. 1A). For instance, the first squeegee 900 and the second squeegee 901 each may include an elongated resiliently deformable blade (rubber blade) having a tapered end section that (in use) contacts the windshield 906. The squeegee includes a flat, smooth rubber blade configured to remove (in use) or control the flow of liquid on a surface (flat or curved) in such a way that the surface can be cleaned. In use, the first squeegee 900 and the second squeegee 901 are swung back and forth (as they are held by the windshield wiper assembly 100) in a windshield-contact condition across the windshield 906. The technical effect of the first squeegee 900 and the second squeegee 901 is to push water and/or debris from the outer surface of the windshield 906, thereby cleaning the windshield 906 for the driver. It will be appreciated that once the first squeegee 900 and the second squeegee 901 are worn out, the windshield wiper assembly 100 is configured to permit replacement of the first squeegee 900 and the second squeegee 901 with newer squeegees (when needed).

The windshield arm 902 (depicted in FIG. 1A) is configured to securely connect to the windshield wiper assembly 100. The windshield arm 902 is a part of the wiper-moving mechanism (known and not depicted) of the vehicle 904. The windshield arm 902 is configured to pivot at one end in such a way as to urge the first squeegee 900 and the second squeegee 901 (that are attached to the windshield wiper assembly 100) to move (swing back and forth) across the outer surface of the windshield 906. The speed of the swinging back-and-forth motion may be adjustable, with several continuous speeds, and may include one or more intermittent settings. For instance, most automobiles use two synchronized radial type windshield arms, and some automobiles and/or commercial vehicles may use a pantograph type windshield arm. The windshield wiper assembly 100 may be configured to be installed to (used with) any one of the synchronized radial type windshield arm and the pantograph type windshield arm.

The vehicle 904 (depicted in FIG. 1A) may include any type of vehicle, such as a motor vehicle, a train, a watercraft, a spacecraft, an aircraft, a bus, a motorbike, a tram, a tractor trailer, and any equivalent thereof, etc. The windshield wiper assembly 100 may be configured to be installed with any type of the vehicle 904.

The windshield 906 (depicted in FIG. 1A) includes the front window of the vehicle 904. The windshield 906 is also called a windscreen. By way of an embodiment, the windshield 906 includes a laminated safety glass (a type of treated glass) having two curved sheets of glass with a plastic layer laminated between them for safety. The laminated safety glass is bonded into a window frame of the vehicle 904. For instance, a motorbike windshield may include a high-impact acrylic plastic. It will be appreciated that the windshield 906 may include the rear window of the vehicle 904 (for the case where the vehicle 904 is driven in a rearward direction). The windshield wiper assembly 100 may be configured and installed for cleaning the rear window of the vehicle 904 for the case where the windshield arm 902 is positioned proximate to the rear window of the vehicle 904.

The windshield fluid reservoir 908 (depicted in FIG. 1A) is configured to contain a washer fluid 910 (depicted in FIG. 3C as being ejected from the windshield wiper assembly 100). For motor vehicles, the windshield fluid reservoir 908 is positioned under the engine hood. The washer fluid 910 may be called a windshield washer fluid, a windshield wiper fluid, wiper fluid, a screen wash or washer fluid. The washer fluid 910 includes a cleaning fluid used in cleaning the windshield 906 with the first squeegee 900 and the second squeegee 901 (once these components are attached to the windshield wiper assembly 100 and operated accordingly).

The windshield wiper assembly 100 includes a windshield arm interface 118 (depicted in FIG. 1B). The windshield arm interface 118 may be called a wiper mounting bracket or a wiper mount. The windshield arm interface 118 is configured to securely connect to the windshield arm 902 of the vehicle 904 (to a distal end thereof). This is done in such a way that the windshield arm interface 118 is positioned proximate to the windshield 906 of the vehicle 904. Preferably, the windshield arm interface 118 is configured to be pivotally attached to the windshield arm 902. Preferably, the windshield arm interface 118 is configured to be universally connectable to a relatively wide variety of types of the windshield arm 902. A technical advantage of the windshield arm interface 118 is that the windshield arm interface 118 may be retrofitted to many types of the vehicle 904 (if so desired).

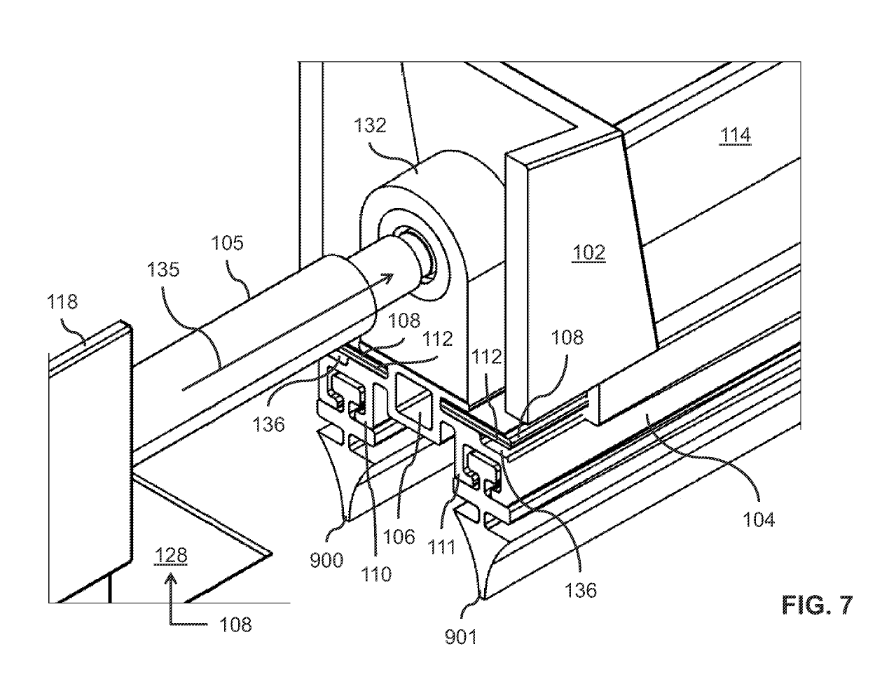

The windshield wiper assembly 100 includes a washer fluid distribution assembly 104 (depicted in FIG. 1B). The washer fluid distribution assembly 104 has an elongated longitudinal length. The washer fluid distribution assembly 104 is configured to provide a washer fluid distribution channel 106 that is depicted in FIG. 3A, FIG. 3B, FIG. 3C and FIG. 7. The washer fluid distribution channel 106 is configured to fluidly connect (directly or indirectly) to the windshield fluid reservoir 908 of the vehicle 904. This is done in such a way that the washer fluid distribution channel 106 conveys, in use, the washer fluid 910 from the windshield fluid reservoir 908 to the windshield 906 of the vehicle 904. A technical advantage of the washer fluid distribution assembly 104 is that the washer fluid distribution assembly 104 facilitates improved cleaning of the windshield 906 (depicted in FIG. 1A) once the washer fluid is made to flow from the windshield fluid reservoir 908 to the windshield 906 (and the first squeegee 900 and the second squeegee 901 are moved to wipe the windshield 906). The washer fluid distribution assembly 104 is configured to eject the washer fluid 910 between the first squeegee 900 and the second squeegee 901, and the wiper path receives the washer fluid over a relatively larger wiper path (on the windshield 906 of FIG. 1A) with less wastage and fewer dry areas on the windshield 906. The washer fluid distribution assembly 104 is configured to be: (A) attachable with the first squeegee 900 and the second squeegee 901, and (B) detachable from the first squeegee 900 and the second squeegee 901. This is done in such a way that the first squeegee 900 and the second squeegee 901 (once installed or attached to the washer fluid distribution assembly 104) are spaced apart from each other and are aligned parallel relative to each other and extend along a longitudinal axis extending through the washer fluid distribution assembly 104. The washer fluid distribution assembly 104 may include an extruded profile having a suitable material (such as, plastic or metal).

The windshield wiper assembly 100 includes a wind deflection cover 114 (depicted in FIG. 1B). The wind deflection cover 114 is configured to connect to the washer fluid distribution assembly 104 (along a top section of the washer fluid distribution assembly 104). The wind deflection cover 114 is configured to extend along a longitudinal length of the windshield wiper assembly 100. The wind deflection cover 114 is configured to deflect wind. This is done in such a way that the wind deflection cover 114 urges (in use) the windshield wiper assembly 100 to push (in use) the first squeegee 900 and the second squeegee 901 toward the windshield 906 in response to the wind pushing the wind deflection cover 114 toward the windshield 906. A technical advantage of the wind deflection cover 114 is that it improves, at least in part, the cleaning action of the first squeegee 900 and the second squeegee 901 once the first squeegee 900 and the second squeegee 901 are activated to be moved across the windshield 906 (depicted in FIG. 1A).

The windshield wiper assembly 100 includes a wiper mount housing 102 (depicted in FIG. 1B) configured to cover the windshield arm interface 118. The windshield arm interface 118 is configured to securely connect to the windshield arm 902 (depicted in FIG. 1A) of the vehicle 904 in such a way that the windshield arm interface 118 is positioned proximate to the windshield 906 of the vehicle 904. The windshield arm interface 118 is configured to securely clamp the central portion of the wind deflection cover 114 to the washer fluid distribution assembly 104. The wiper mount housing 102 simply provides a protective cover (guard) for the windshield arm interface 118.

The windshield wiper assembly 100 includes end caps 116 (depicted in FIG. 1B). The end caps 116 are configured to clamp opposite distal end portions of the wind deflection cover 114 to the washer fluid distribution assembly 104 (to the top portion or side portions thereof). In accordance with a preferred embodiment, the end caps 116 are configured to retain (at least in part) the first squeegee 900 and the second squeegee 901 in place.

In summary, the windshield wiper assembly 100 is for the first squeegee 900, the second squeegee 901 and the windshield arm 902 of the vehicle 904 having the windshield 906 and the windshield fluid reservoir 908 configured to contain the washer fluid 910. The windshield wiper assembly 100 includes the washer fluid distribution assembly 104 configured to be mounted (directly or indirectly) to the windshield arm 902. The washer fluid distribution assembly 104 includes spaced apart squeegee holders (110, 111) configured to securely receive the first squeegee 900 and the second squeegee 901 in which this is done in such a way that the first squeegee 900 and the second squeegee 901 are spaced apart from each other once securely received by the spaced apart squeegee holders. The washer fluid distribution assembly 104 provides a washer fluid distribution channel 106 configured to convey (directly or indirectly), in use, the washer fluid 910 from the windshield fluid reservoir 908 of the vehicle 904 to between the first squeegee 900 and the second squeegee 901.

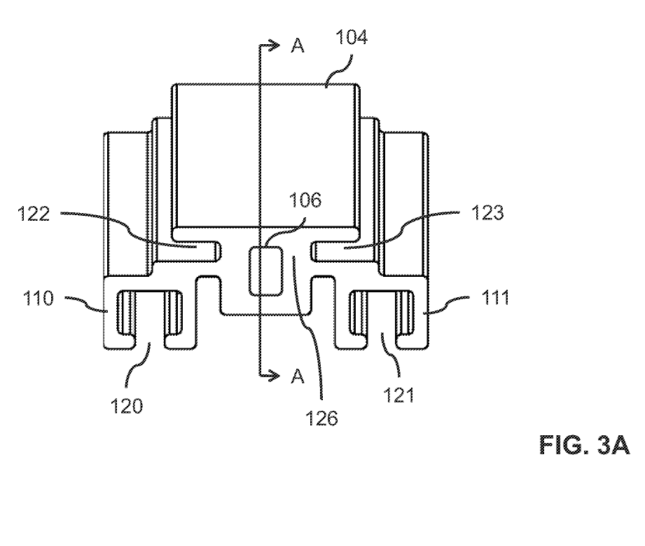

FIG. 2 depicts an exploded view of an embodiment of the windshield wiper assembly 100 of FIG. 1A.

The washer fluid distribution assembly 104 is configured to securely connect to the windshield arm interface 118 (depicted in FIG. 2). This is done in such a way that the washer fluid distribution assembly 104 is positioned proximate to the windshield 906 of the vehicle 904 once the washer fluid distribution assembly 104 is securely connected to the windshield arm interface 118.

The wind deflection cover 114 includes a first deflection cover section 114A and a second deflection cover section 114B (both depicted in FIG. 2). The windshield arm interface 118 is positioned between the first deflection cover section 114A and the second deflection cover section 114B once the windshield arm interface 118 is installed to the washer fluid distribution assembly 104. A technical advantage of the wind deflection cover 114 is that it improves, at least in part, the cleaning action of the first squeegee 900 and the second squeegee 901 once the first squeegee 900 and the second squeegee 901 are activated to be moved across the windshield 906 (depicted in FIG. 1A).

The washer fluid distribution assembly 104 is further configured to provide a washer fluid hose 105 (depicted in FIG. 2). The washer fluid hose 105 is configured to fluidly connect (directly or indirectly) with the washer fluid distribution channel 106 (depicted in FIGS. 3A, 3B, 3C and 7) and with the windshield fluid reservoir 908 (depicted in FIG. 1A). This is done in such a way that the washer fluid may be conveyed from the windshield fluid reservoir 908 to the washer fluid distribution channel 106, once it is required to eject the washer fluid to the windshield 906 (depicted in FIG. 1A). The user has access to wiper controls mounted in the passenger compartment of the vehicle 904, and the wiper controls are configured to operate a pump assembly (know and not depicted) configured to urge the flow of the washer fluid from the windshield fluid reservoir 908, along the washer fluid hose 105 to the washer fluid distribution assembly 104, and then to the windshield 906.

The washer fluid distribution assembly 104 is further configured to receive a heater assembly 108 (depicted in FIG. 2). The heater assembly 108 is configured to convey heat, in use, to the washer fluid distribution assembly 104 (once installed to the washer fluid distribution assembly 104). A technical effect (advantage) of the heater assembly 108 is that in relatively colder climate conditions, the heater assembly 108 may be activated in such a way the build-up of ice and/or snow positioned proximate to the first squeegee 900 and the second squeegee 901 may be melted. In this arrangement, the windshield wiper assembly 100 may be moved to wipe the windshield 906 (depicted in FIG. 1A) in cold-climate conditions after the heater assembly 108 is activated. The heater assembly 108 includes an electrical connector 109 configured to electrically connect (directly or indirectly) the heater assembly 108 to the electrical system (to the battery) of the vehicle 904 (depicted in FIG. 1A). The heater assembly 108 is configured to be electrically connected (directly or indirectly) to the electrical system of the vehicle 904 (specifically, either directly or indirectly to the batter of the vehicle 904).

As depicted in FIG. 2, the washer fluid distribution assembly 104 is configured to hold the first squeegee 900 and the second squeegee 901 spaced apart from each other. The technical advantage of this arrangement is that the washer fluid is ejected between the space formed between the first squeegee 900 and the second squeegee 901 (since they are spaced apart from each other). Once the first squeegee 900 and the second squeegee 901 are moved to wipe the windshield 906 (depicted in FIG. 1A), the washer fluid that is ejected toward the windshield 906 may be utilized by both the first squeegee 900 and the second squeegee 901 (thereby improving the cleaning action of the first squeegee 900 and the second squeegee 901).

The washer fluid distribution assembly 104 is further configured to receive a spring assembly 112 (depicted in FIG. 2). The spring assembly 112 is configured to impart a biasing force to the section of the washer fluid distribution assembly 104 that is configured to hold the first squeegee 900 and the second squeegee 901. This is done in such a way that the biasing force (provided by the spring assembly 112) urges the first squeegee 900 that is securely held (and received) by the wind deflection cover 114 toward the windshield 906, and also urges the second squeegee 901 that is securely held (and received) by the wind deflection cover 114 toward the windshield 906.

FIGS. 3A, 3B, 3C and 3D depict views of embodiments of a washer fluid distribution assembly 104 of the windshield wiper assembly 100 of FIG. 1A. FIG. 3A depicts a perspective view of an embodiment of the washer fluid distribution assembly 104. FIG. 3B depicts a cross-sectional view of an embodiment of the washer fluid distribution assembly 104 of FIG. 3A through the cross-sectional line A-A. FIG. 3C depicts an end view of an embodiment of the washer fluid distribution assembly 104 of FIG. 3A.

In accordance with the embodiments as depicted in FIGS. 3A, 3B and 3C, the washer fluid distribution assembly 104 includes an elongated extruded body profile that may be made of a plastic material or a metal alloy (such as, aluminum), etc. The technical advantage of the elongated extruded body profile is that the washer fluid distribution assembly 104 is easier (at least in part) to manufacture thereby reducing the cost to the driver of the vehicle 904, and/or also improves (at least in part) the integration of the components used with the washer fluid distribution assembly 104. The washer fluid distribution assembly 104 is configured to integrate the components used with the washer fluid distribution assembly 104.

The washer fluid distribution assembly 104 is configured to provide (define) a first squeegee holder 110 (depicted in FIG. 3A). The first squeegee holder 110 may be called a squeegee interface. The first squeegee holder 110 may form a C-shaped cross-sectional profile. The first squeegee holder 110 forms (provides) a first squeegee gap 120 configured to securely receive the first squeegee 900. The first squeegee holder 110 extends from the wind deflection cover 114. The first squeegee holder 110 is configured to securely receive the first squeegee 900 (as depicted in FIG. 7). This is done in such a way that the first squeegee 900 (in use) contacts the windshield 906 (depicted in FIG. 1A) once the washer fluid distribution assembly 104 is positioned just so (once the washer fluid distribution assembly 104 is positioned proximate to the windshield 906).

The washer fluid distribution assembly 104 is configured to provide (define) a second squeegee holder 111 (depicted in FIG. 3A). The second squeegee holder 111 may be called a squeegee interface. The second squeegee holder 111 may form a C-shaped cross-sectional profile. The second squeegee holder 111 forms (provides) a second squeegee gap 121 configured to securely receive the second squeegee 901. The second squeegee holder 111 extends from the wind deflection cover 114. The second squeegee holder 111 and the first squeegee holder 110 are spaced apart from each other. The second squeegee holder 111 is configured to securely receive the second squeegee 901 (as depicted in FIG. 7). This is done in such a way that the second squeegee 901 (in use) contacts the windshield 906 once the washer fluid distribution assembly 104 is positioned just so (once the washer fluid distribution assembly 104 is positioned proximate to the windshield 906). Once mounted to the washer fluid distribution assembly 104, the second squeegee holder 111 is spatially spaced apart (set apart) from the first squeegee holder 110. The first squeegee holder 110 and the second squeegee holder 111 each face outwardly from the same side (the bottom side) of the washer fluid distribution assembly 104, and each extend along a length of the washer fluid distribution assembly 104.

The washer fluid distribution assembly 104 is further configured to provide (define) the washer fluid distribution channel 106 (FIG. 3A). The washer fluid distribution channel 106 is positioned in a central portion of the washer fluid distribution assembly 104. The washer fluid distribution channel 106 extends along a longitudinal length of the washer fluid distribution assembly 104. The washer fluid distribution channel 106 is configured to fluidly connect (directly or indirectly) to the windshield fluid reservoir 908 of the vehicle 904 (depicted in FIG. 1A). This is done in such a way that the washer fluid distribution channel 106 conveys (in use) the washer fluid 910 from the windshield fluid reservoir 908 to the windshield 906 of the vehicle 904. The washer fluid distribution channel 106 is positioned between the second squeegee holder 111 and the first squeegee holder 110.

In accordance with a preferred embodiment, the washer fluid distribution assembly 104 provides (forms) a T-shaped centrally positioned post 126, with the washer fluid distribution channel 106 formed centrally within the T-shaped centrally positioned post 126. The heater assembly 108 is configured to provide heat (at least in part) to the first squeegee 900 and the second squeegee 901 in such a way that formation of ice on the first squeegee 900 and the second squeegee 901 is reduced at least in part (preferably prevented altogether if possible. Another technical effect is that this arrangement assists in guarding the integrity of the washer fluid distribution channel 106 by providing a relatively even amount of the material of the T-shaped centrally positioned post 126 around the washer fluid distribution channel 106.

The washer fluid distribution assembly 104 is further configured to provide (define) a set of washer fluid outlets 124 (FIG. 3B). The set of washer fluid outlets 124 are spaced apart from each other, and extend from the washer fluid distribution channel 106 in such a way that the set of washer fluid outlets 124 faces (in use) the windshield 906 (as depicted in FIG. 1A). The set of washer fluid outlets 124 are configured to convey the washer fluid from the washer fluid distribution channel 106 to the windshield 906. The set of washer fluid outlets 124 is in fluid communication with the washer fluid distribution channel 106.

The washer fluid distribution assembly 104 is further configured to receive the heater assembly 108 (depicted in FIG. 3C). The heater assembly 108 is configured to convey heat, in use, to the washer fluid distribution assembly 104. The washer fluid distribution assembly 104 is further configured to receive the spring assembly 112 (depicted in FIG. 3C). The spring assembly 112 is configured to impart a biasing force to the first squeegee holder 110 and to the second squeegee holder 111. This is done in such a way that the biasing force urges the first squeegee 900 that is securely received by the first squeegee holder 110 toward the windshield 906 (as depicted in FIG. 1A), and also urges the second squeegee 901 that is securely received by the second squeegee holder 111 toward the windshield 906. Preferably, the heater assembly 108 extends a full width of the spring assembly 112, and in this manner the heater assembly 108 may, in use, transfer relatively more heat to the spring assembly 112.

In accordance with a preferred embodiment, the washer fluid distribution assembly 104 is configured to provide (define) a first groove 122 and a second groove 123 that is spaced apart from the first groove 122. The first groove 122 and the second groove 123 are configured to receive (slidably receive) the heater assembly 108 and the spring assembly 112 (as depicted in FIG. 3C). The first groove 122 and the second groove 123 each face outwardly from opposite longitudinal sides of the washer fluid distribution assembly 104, and each extend along a length of the washer fluid distribution assembly 104. The first groove 122 and the second groove 123 are formed above the first squeegee holder 110 and the second squeegee holder 111, respectively.

In accordance with a preferred embodiment, the heater assembly 108 is positioned on top of the spring assembly 112 (once received in the first groove 122 and the second groove 123).

Once the heater assembly 108 and the spring assembly 112 are mounted to the washer fluid distribution assembly 104, the wind deflection cover 114 may be installed to the washer fluid distribution assembly 104. In accordance with a preferred embodiment, the wind deflection cover 114 provides an extension portion, and the extension portion (a lateral extension portion) is configured to be received between the spring assembly 112 and the washer fluid distribution assembly 104.

In accordance with a preferred embodiment, the wind deflection cover 114 (as depicted in FIG. 3C) has a height that is about 75 percent of the width. The wind deflection cover 114 provides (forms) opposite sides each having (presenting) a concave shape.

Preferably, the windshield wiper assembly 100 is installed the much the same way as the existing wiper assemblies are installed.

By ejecting the washer fluid 910 between the first squeegee 900 and the second squeegee 901, the wiper path receives the washer fluid over a relatively larger wiper path (on the windshield 906 of FIG. 1A) with less wastage and fewer dry areas on the windshield 906.

The heater assembly 108 is positioned (mounted) in the washer fluid distribution assembly 104 in such a way that the washer fluid distribution assembly 104 reduces formation of ice on the windshield wiper assembly 100. The formation of ice on the windshield wiper assembly 100 leads to the unwanted formation of streaks and therefore reduces visibility. The heater assembly 108, in use, reduces (at least in part) the formation of unwanted streaks on the windshield 906, thereby improving (at least in part) visibility through the windshield 906 (for the driver of the vehicle 904). The heater assembly 108 is configured to be powered by the electrical system of the vehicle 904 (depicted in FIG. 1A). The electrical wiring for the heater assembly 108 is routed according to the layout of the vehicle 904.

The washer fluid distribution assembly 104 provides the set of washer fluid outlets 124 positioned between the first squeegee 900 and the second squeegee 901 (depicted in FIG. 2). In accordance with a preferred embodiment, the first squeegee 900 and the second squeegee 901 are replaceable.

Preferably, the windshield wiper assembly 100 provides the set of washer fluid outlets 124 and the heater assembly 108 to prevent ice buildup in snowstorms, etc.

In accordance with a preferred embodiment, the washer fluid distribution assembly 104 provides or defines two parallel spaced-apart holders for receiving respective squeegees with the washer fluid distribution assembly 104 positioned there between. The set of washer fluid outlets 124 is positioned along the assembly at several positions, with emphasis on the part of the squeegee that wipes the upper windshield section of the windshield 906 (depicted in FIG. 1A), as this is the area where existing wiper assemblies tend to fail to dispense the washer fluid, resulting in a windshield that be difficult to see through, and which can create dangerously-reduced visibility.

The built-in spray jets (that is, the outlets 144 provided by the washer fluid distribution assembly 104) apply the washer fluid directly to the portion of the windshield 906 where the first squeegee 900 and the second squeegee 901 are moved thereon. This arrangement reduces (at least in part) wastage of the washing fluid (that is, the washing fluid is not spread over parts of the windshield 906 that are not touched by the first squeegee 900 and the second squeegee 901). Also, by ejecting the washer fluid from between the two spaced apart squeegees (the first squeegee 900 and the second squeegee 901) that are mounted to the washer fluid distribution assembly 104, the washer fluid is channeled along a greater length of the windshield wiper assembly 100. In this arrangement, the windshield wiper assembly 100 leaves (in use) fewer dry spots and/or dirty spots behind on the windshield 906. The heater assembly 108 may be used (actuated) during a snow storm (an adverse cold-weather condition) to provide (in use) heat (thermal energy) to the washer fluid distribution assembly 104, thereby reducing (at least in part) the accumulation of ice and snow on the wiper blades (that is, the first squeegee 900 and the second squeegee 901), and/or thereby reducing the formation of unwanted vision-blocking streaks on the windshield 906.

In accordance with an embodiment as depicted in FIG. 3D, the washer fluid distribution assembly 104 is configured to provide a lamp 127 (such as a light emitting diode) configured to indicate, to the driver, that the heating assembly 108 is energized (if so desired). The lamp 127 is positioned, preferably, proximate to the end portion of the washer fluid distribution assembly 104.

To summarize, the washer fluid distribution assembly 104 is configured to be mounted to the windshield arm 902. The washer fluid distribution assembly 104 includes spaced apart squeegee holders (110, 111) configured to securely receive the first squeegee 900 and the second squeegee 901. The washer fluid distribution assembly 104 provides the washer fluid distribution channel 106 configured to convey, in use, the washer fluid from the windshield fluid reservoir 908 of the vehicle 904 to between the first squeegee 900 and the second squeegee 901 (that are held by the spaced apart squeegee holders 110, 111).

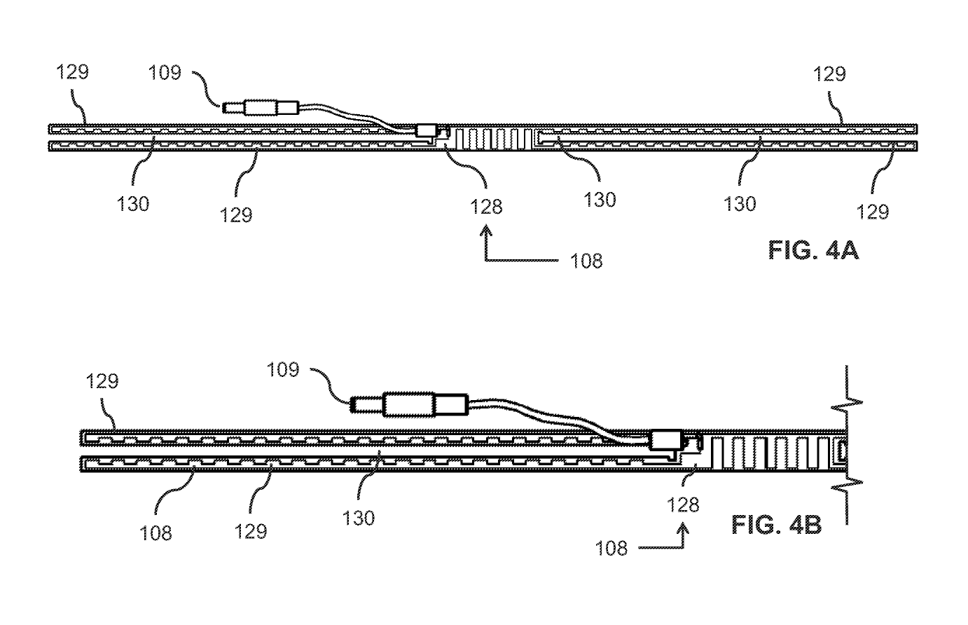

FIGS. 4A and 4B depict views of embodiments of a heater assembly 108 of the windshield wiper assembly 100 of FIG. 1A.

In accordance with the embodiments as depicted in FIGS. 4A and 4B, the heater assembly 108 provides a central portion 128 having opposite sides. The electrical connector 109 is fixedly attached to the central portion 128. The heater assembly 108 provides heater forks 129 that extend from the opposite sides of the central portion 128. Between the heater forks 129 there is defined a heater channel 130. The heater channel 130 (as depicted in FIG. 4A) is configured to slidably fit along the opposite sides of the washer fluid distribution assembly 104 (such as, the T-shaped centrally positioned post 126 as depicted in FIG. 3A) and along the first groove 122 and the second groove 123 provided by the washer fluid distribution assembly 104. This is done in such a way that the heater forks 129 are received in a respective one of the first groove 122 and the second groove 123.

In accordance with a preferred embodiment, the heater forks 129 form a relatively thin printed circuit heater. Preferably, the heater assembly 108 includes a printed circuit heater that is printed on a substrate material.

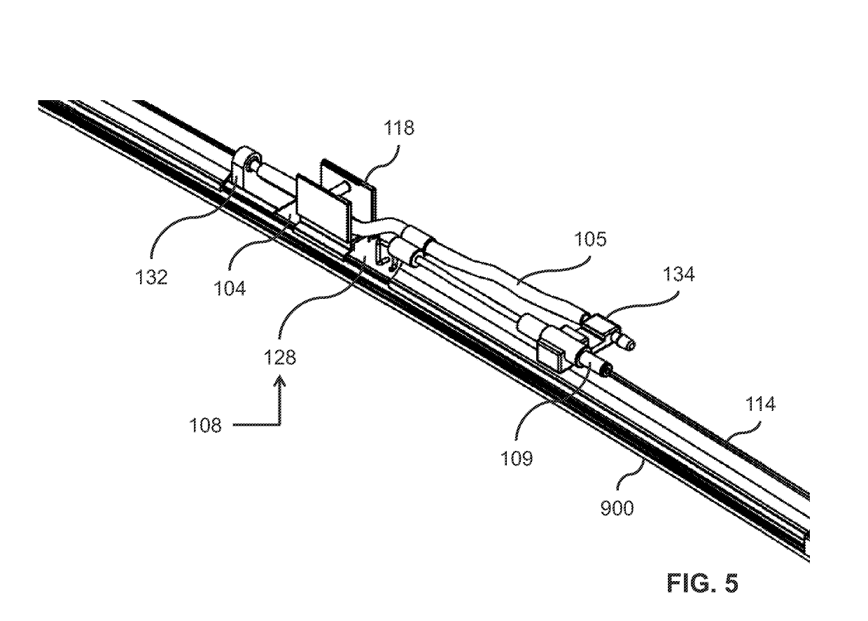

FIG. 5 depicts a central perspective view of a central section of an embodiment of the heater assembly 108 of the windshield wiper assembly 100 of FIG. 4A.

In accordance with the embodiment as depicted in FIG. 5, the central portion 128 of the heater assembly 108 is configured to fit (slide fit), at least in part, with the windshield arm interface 118. Once the central portion 128 is received by the windshield arm interface 118, then the heater forks 129 (depicted in FIG. 4A) are received (at least in part) in the washer fluid distribution assembly 104.

The washer fluid distribution assembly 104 further includes a check valve assembly 132 configured to be in fluid communication with the washer fluid distribution channel 106 (as depicted in FIG. 3C) provided by the washer fluid distribution assembly 104. The end portions 107 (depicted in FIG. 2) of the washer fluid distribution assembly 104 are each configured to be plugged (with respective plugs). This is done in such a way that the washer fluid is prevented (at least in part) from escaping (leaking) from the end portions 107, and the washer fluid is thereby forced to exit (under pressure) from the washer fluid distribution assembly 104 through the washer fluid outlets 124 (also called the jets). The check valve assembly 132 is configured to prevent the back flow of the washer fluid along the washer fluid hose 105 toward the windshield fluid reservoir 908 (depicted in FIG. 1A). A technical effect of the check valve assembly 132 is to prevent leakage from the washer fluid distribution channel 106 so that there is washer fluid available when needed to clean the windshield 906 (depicted in FIG. 1A).

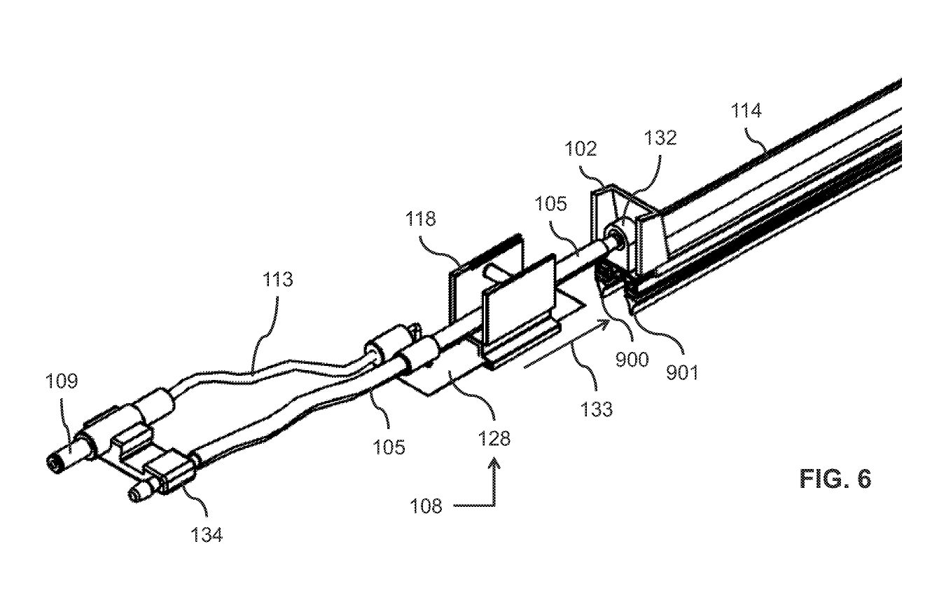

FIG. 6 depicts a partially exploded view of a central section of an embodiment of the heater assembly 108 of the windshield wiper assembly 100 of FIG. 4A.

In accordance with the embodiment as depicted in FIG. 6, an electrical wire 113 electrically connects the electrical connector 109 to the central portion 128 of the heater assembly 108. Once the central portion 128 is received by the windshield arm interface 118, then the heater forks 129 (depicted in FIG. 4A) are received in the washer fluid distribution assembly 104 (along a slide direction 133).

The washer fluid distribution assembly 104 further includes a support bracket 134 configured to support the washer fluid hose 105 and the electrical connector 109 (at a stable position) relative to the windshield arm interface 118. It will be appreciated that what is depicted in FIG. 6 is a cutaway view of the wiper mount housing 102 (for improved view of the check valve assembly 132). The wiper mount housing 102 is configured to protect (guard) the check valve assembly 132 once positioned to do just so, and is also configured to protect the windshield arm interface 118 (from inadvertent damage).

FIG. 7 depicts a perspective view of an embodiment of a check valve assembly 132 of the windshield wiper assembly 100 of FIG. 1A. It will be appreciated that FIG. 7 depicts a cutaway view of the wiper mount housing 102.

In accordance with the embodiment as depicted in FIG. 7, the wind deflection cover 114 is extended away (retracted) from the check valve assembly 132 (to improve the view of the washer fluid distribution channel 106). The washer fluid is made to flow along a fluid flow direction 135 through the washer fluid hose 105 toward the check valve assembly 132.

Cover channels 136 are provided (defined by) the placement (position) of the heater assembly 108 and the spring assembly 112 in the washer fluid distribution assembly 104 (also depicted in FIG. 3C). The cover channels 136 are positioned on the opposite lateral sides of the washer fluid distribution assembly 104. The cover channels 136 are configured to receive respective edge sections of the wind deflection cover 114 in such a way that the wind deflection cover 114 is securely engaged with the washer fluid distribution assembly 104.

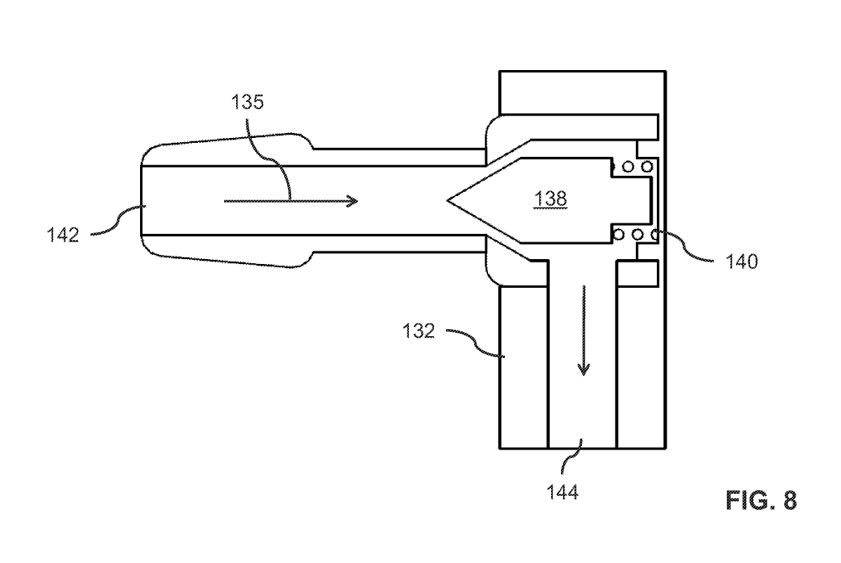

FIG. 8 depicts a cross-sectional side view of an embodiment of the check valve assembly 132 of the windshield wiper assembly 100 of FIG. 7.

In accordance with the embodiment as depicted in FIG. 8, the check valve assembly 132 includes a check valve 138 positioned within the check valve assembly 132. The check valve 138 is spring biased toward a closed position by a valve spring 140 mounted in the check valve assembly 132. The check valve 138 and the valve spring 140 are configured (in combination) to prevent the backflow of the washer fluid from the washer fluid distribution assembly 104 toward the windshield fluid reservoir 908 (as depicted in FIG. 1A). The check valve assembly 132 provides (defines) an inlet 142 configured to fluidly communicate (directly or indirectly) with the washer fluid hose 105 (depicted in FIG. 7). The check valve assembly 132 provides (defines) an outlet 144 configured to fluidly communicate (directly or indirectly) with the washer fluid distribution channel 106 (as depicted in FIG. 7).

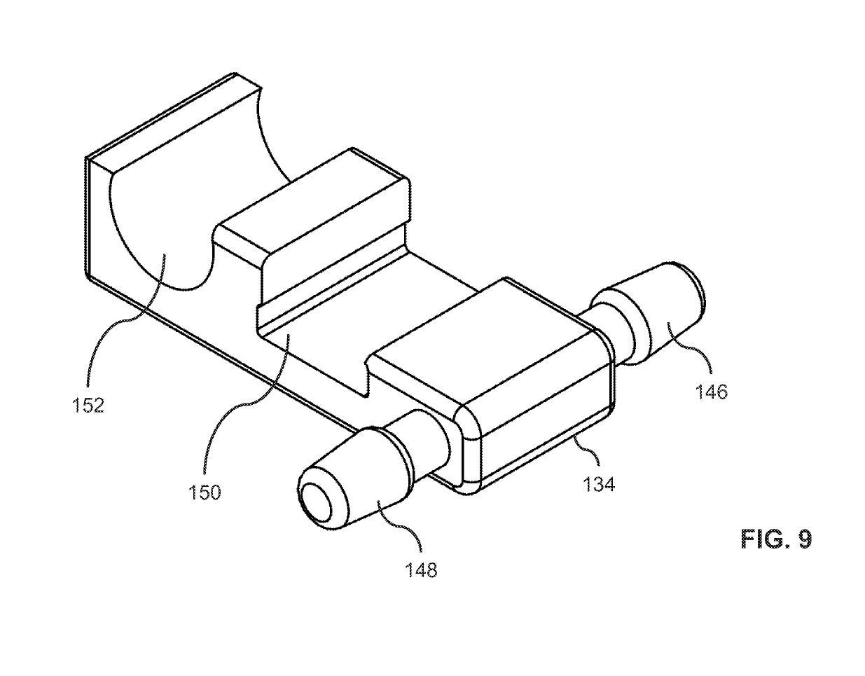

FIG. 9 depicts a perspective view of an embodiment of a support bracket 134 of the windshield wiper assembly 100 of FIG. 1A.

In accordance with the embodiment as depicted in FIG. 9, the support bracket 134 provides a first hose connection 146 and a second hose connection 148 each extending from a body of the support bracket 134. The first hose connection 146 and the second hose connection 148 are in fluid communication with each other. The first hose connection 146 is configured to be in fluid communication with the washer fluid hose 105 (as depicted in FIG. 6) The second hose connection 148 is configured to be in fluid communication with a tube (known and not depicted) that connects with the windshield fluid reservoir 908 (as depicted in FIG. 1A).

The support bracket 134 provides an arm receiver 150 configured to receive (fit with) the windshield arm 902 (as depicted in FIG. 1A). The support bracket 134 provides an electrical receiver 152 configured to receive (fit with) the electrical connector 109 (as depicted in FIG. 6).

This written description uses examples to disclose the invention, including the best mode, and also to enable any person skilled in the art to make and use the invention. The patentable scope of the invention is defined by the claims, and may include other examples that occur to those skilled in the art. Such other examples are within the scope of the claims if they have structural elements that do not differ from the literal language of the claims, or if they include equivalent structural elements with insubstantial differences from the literal language of the claims.

It may be appreciated that the assemblies and modules described above may be connected to each other as required to perform desired functions and tasks within the scope of persons of skill in the art to make such combinations and permutations without having to describe each and every one in explicit terms. There is no particular assembly or component that may be superior to any of the equivalents available to the person skilled in the art. There is no particular mode of practicing the disclosed subject matter that is superior to others, so long as the functions may be performed. It is believed that all the crucial aspects of the disclosed subject matter have been provided in this document. It is understood that the scope of the present invention is limited to the scope provided by the independent claim(s), and it is also understood that the scope of the present invention is not limited to: (i) the dependent claims, (ii) the detailed description of the non-limiting embodiments, (iii) the summary, (iv) the abstract, and/or (v) the description provided outside of this document (that is, outside of the instant application as filed, as prosecuted, and/or as granted). It is understood, for this document, that the phrase “includes” is equivalent to the word “comprising.” The foregoing has outlined the non-limiting embodiments (examples). The description is made for particular non-limiting embodiments (examples). It is understood that the non-limiting embodiments are merely illustrative as examples.

What is claimed is:

1. A windshield wiper assembly for a first squeegee, a second squeegee and a windshield arm of a vehicle having a windshield and a windshield fluid reservoir configured to contain a washer fluid, the windshield wiper assembly comprising:
a washer fluid distribution assembly being configured to be mounted to the windshield arm;
the washer fluid distribution assembly including spaced apart squeegee holders configured to securely receive the first squeegee and the second squeegee; and
the washer fluid distribution assembly providing a washer fluid distribution channel configured to convey, in use, the washer fluid from the windshield fluid reservoir of the vehicle to between the first squeegee and the second squeegee.

2. The windshield wiper assembly of claim 1, further comprising:
a windshield arm interface being configured to securely connect to the windshield arm of the vehicle in such a way that the windshield arm interface is positioned proximate to the windshield of the vehicle; and
the washer fluid distribution assembly is configured to securely connect to the windshield arm interface in such a way that the washer fluid distribution assembly is positioned proximate to the windshield of the vehicle once the washer fluid distribution assembly is securely connected to the windshield arm interface.

3. The windshield wiper assembly of claim 1, wherein:
the washer fluid distribution assembly is configured to:
provide a first squeegee holder being configured to securely receive the first squeegee in such a way that the first squeegee, in use, contacts the windshield once the washer fluid distribution assembly is positioned just so; and
provide a second squeegee holder being configured to securely receive the second squeegee in such a way that the second squeegee, in use, contacts the windshield once the washer fluid distribution assembly is positioned just so, and the second squeegee holder is spaced apart from the first squeegee holder.

4. The windshield wiper assembly of claim 3, wherein:
the washer fluid distribution channel is configured to fluidly connect to the windshield fluid reservoir of the vehicle in such a way that the washer fluid distribution channel conveys the washer fluid from the windshield fluid reservoir to the windshield of the vehicle; and
the washer fluid distribution channel is configured to eject the washer fluid between the first squeegee and the second squeegee in such a way that a wiper path receives the washer fluid over a relatively larger wiper path on the windshield with less wastage and fewer dry areas on the windshield.

5. The windshield wiper assembly of claim 4, wherein:
the washer fluid distribution channel is positioned between the second squeegee holder and the first squeegee holder.

6. The windshield wiper assembly of claim 1, wherein:
the washer fluid distribution assembly is further configured to receive a heater assembly being configured to convey heat, in use, to the washer fluid distribution assembly.

7. The windshield wiper assembly of claim 3, wherein:
the washer fluid distribution assembly is further configured to receive a spring assembly being configured to impart a biasing force to the first squeegee holder and to the second squeegee holder in such a way that a biasing force urges the first squeegee that is securely received by the first squeegee holder toward the windshield and also urges the second squeegee that is securely received by the second squeegee holder toward the windshield.

8. The windshield wiper assembly of claim 1, further comprising:
a wind deflection cover being configured to:
connect to the washer fluid distribution assembly;
extend along a longitudinal length of the windshield wiper assembly; and
deflect wind in such a way that the wind deflection cover, in use, urges the windshield wiper assembly to push, in use, the first squeegee and the second squeegee toward the windshield in response to the wind pushing the wind deflection cover toward the windshield, and the wind deflection cover improving, at least in part, a cleaning action of the first squeegee and the second squeegee once the first squeegee and the second squeegee are activated to be moved across the windshield.

9. The windshield wiper assembly of claim 8, further comprising:
end caps being configured to:
clamp opposite distal end portions of the wind deflection cover to the washer fluid distribution assembly; and
retain, at least in part, the first squeegee and the second squeegee in place.

10. The windshield wiper assembly of claim 2, further comprising:
a washer fluid hose being configured to fluidly connect to the washer fluid distribution channel with the windshield fluid reservoir in such a way that the washer fluid is conveyable from the windshield fluid reservoir to the washer fluid distribution channel.

11. The windshield wiper assembly of claim 6, wherein:
the heater assembly includes:
an electrical connector configured to electrically connect the heater assembly to an electrical system of the vehicle.

12. The windshield wiper assembly of claim 1, wherein:
the washer fluid distribution assembly includes:
an elongated extruded body profile configured to integrate components used with the washer fluid distribution assembly.

13. The windshield wiper assembly of claim 2, wherein:
the washer fluid distribution assembly provides a T-shaped centrally positioned post; and
the washer fluid distribution channel is formed centrally within the T-shaped centrally positioned post.

14. The windshield wiper assembly of claim 2, wherein:
the washer fluid distribution assembly is further configured to provide:
a set of washer fluid outlets being spaced apart from each other, and extending from the washer fluid distribution channel in such a way that the set of washer fluid outlets, in use, faces the windshield; and
the set of washer fluid outlets being configured to convey, in use, the washer fluid from the washer fluid distribution channel to the windshield.

15. The windshield wiper assembly of claim 6, wherein:
the washer fluid distribution assembly is configured to provide:
a first groove; and
a second groove being spaced apart from the first groove;
the first groove and the second groove being configured to receive the heater assembly;
the first groove and the second groove each facing outwardly from opposite longitudinal sides of the washer fluid distribution assembly;
the first groove and the second groove each extending along a length of the washer fluid distribution assembly; and
the first groove and the second groove being formed above a first squeegee holder and a second squeegee holder, respectively.

16. The windshield wiper assembly of claim 3, wherein:
the washer fluid distribution assembly is further configured to:
receive a heater assembly being configured to convey heat, in use, to the washer fluid distribution assembly;
receive a spring assembly being configured to impart a biasing force to the first squeegee holder and to the second squeegee holder in such a way that a biasing force urges the first squeegee that is securely received by the first squeegee holder toward the windshield and also urges the second squeegee that is securely received by the second squeegee holder toward the windshield;
provide a first groove; and
provide a second groove being spaced apart from the first groove;
the first groove and the second groove being configured to receive the heater assembly and the spring assembly;
the first groove and the second groove each facing outwardly from opposite longitudinal sides of the washer fluid distribution assembly;
the first groove and the second groove each extending along a length of the washer fluid distribution assembly; and
the first groove and the second groove being formed above the first squeegee holder and the second squeegee holder, respectively.

17. The windshield wiper assembly of claim 6, wherein:
the heater assembly provides:
a central portion having opposite sides, and the central portion configured to fit with a windshield arm interface;
heater forks extending from the opposite sides of the central portion; and
a heater channel defined between the heater forks, and the heater channel is configured to slidably fit along the opposite sides of the washer fluid distribution assembly and along a first groove and a second groove provided by the washer fluid distribution assembly in such a way that the heater forks are receivable in a respective one of the first groove and the second groove.

18. The windshield wiper assembly of claim 2, wherein:
the washer fluid distribution assembly further includes:
a check valve assembly configured to be in fluid communication with the washer fluid distribution channel; and
the check valve assembly being configured to prevent a back flow of the washer fluid along a washer fluid hose toward the windshield fluid reservoir.

19. A windshield wiper assembly for a first squeegee, a second squeegee and a windshield arm of a vehicle having a windshield and a windshield fluid reservoir being configured to contain a washer fluid, the windshield wiper assembly comprising:
a windshield arm interface being configured to securely connect to the windshield arm of the vehicle in such a way that the windshield arm interface is positioned proximate to the windshield of the vehicle; and
a washer fluid distribution assembly being configured to:
securely connect to the windshield arm interface in such a way that the washer fluid distribution assembly is positioned proximate to the windshield of the vehicle once the washer fluid distribution assembly is securely connected to the windshield arm interface;
provide a first squeegee holder being configured to securely receive the first squeegee in such a way that the first squeegee, in use, contacts the windshield once the washer fluid distribution assembly is positioned just so;
provide a second squeegee holder being configured to securely receive the second squeegee in such a way that the second squeegee, in use, contacts the windshield once the washer fluid distribution assembly is positioned just so, and the second squeegee holder is spaced apart from the first squeegee holder;
provide a washer fluid distribution channel being configured to fluidly connect to the windshield fluid reservoir of the vehicle in such a way that the washer fluid distribution channel conveys the washer fluid from the windshield fluid reservoir to the windshield of the vehicle, and the washer fluid distribution channel is positioned between the second squeegee holder and the first squeegee holder;
receive a heater assembly being configured to convey heat, in use, to the washer fluid distribution assembly; and
receive a spring assembly being configured to impart a biasing force to the first squeegee holder and to the second squeegee holder in such a way that a biasing force urges the first squeegee that is securely received by the first squeegee holder toward the windshield and also urges the second squeegee that is securely received by the second squeegee holder toward the windshield.

20. An apparatus, comprising:
a first squeegee;
a second squeegee;
a vehicle having a windshield arm, a windshield and a windshield fluid reservoir being configured to contain a washer fluid;
a windshield wiper assembly including:
a windshield arm interface being configured to securely connect to the windshield arm of the vehicle in such a way that the windshield arm interface is positioned proximate to the windshield of the vehicle; and
a washer fluid distribution assembly being configured to:
securely connect to the windshield arm interface in such a way that the washer fluid distribution assembly is positioned proximate to the windshield of the vehicle once the washer fluid distribution assembly is securely connected to the windshield arm interface;
provide a first squeegee holder being configured to securely receive the first squeegee in such a way that the first squeegee, in use, contacts the windshield once the washer fluid distribution assembly is positioned just so; and
provide a second squeegee holder being configured to securely receive the second squeegee in such a way that the second squeegee, in use, contacts the windshield once the washer fluid distribution assembly is positioned just so, and the second squeegee holder is spaced apart from the first squeegee holder.
